(19) United States
(12) Patent Application Publication
(10) Pub. No.: US 2011/0000786 A1
(43) Pub. Date: Jan. 6, 2011

(54) PROCESS FOR PRODUCING ELECTRET FINE PARTICLES

(75) Inventors: Hiroshi Inoue, Osaka (JP); Masahiro Okuda, Tenri-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SAKURA COLOR PRODUCTS CORPORATION, Osaka (JP)

(21) Appl. No.: 12/718,409

(22) Filed: Mar. 5, 2010

(30) Foreign Application Priority Data
Jul. 6, 2009 (JP) 2009-159760

(51) Int. Cl. H01G 9/022

(52) U.S. Cl. 204/450

(57) ABSTRACT

The subject invention provides a method which enables easy and efficient production of fine electret fine particles without the conventional pulverization or screening process.

The method of producing electret fine particles comprises emulsifying a fluorine-containing compound in the liquid phase under atmospheric or elevated pressure in a liquid incompatible with the fluorine-containing compound, to obtain emulsified particles, and irradiating the emulsified particles with an electron ray or a radial ray.

### TECHNICAL FIELD

The present invention relates to a process for producing electret fine particles that are useful as electrophoretic fine particles used for a full-color electrophoretic display apparatus (so-called “electronic paper”).

### BACKGROUND ART

In recent years, the electrophoretic display method, which employs the electrophoresis of charged fine particles (electret fine particles), has been attracting attention as the most promising technology for a next-generation display apparatus. However, this technology still has many problems including the shape of charged fine particles, small and unstable charge potential (ζpotential), secondary aggregation or sedimentation of electrophoretic particles, inadequate deletion of previously displayed images, unsatisfactory response speed, and the like.

Patent Literatures 1 and 2 disclose electret fine particles used as a powder material for an image display apparatus. More specifically, Patent Literature 1 teaches the production of positively-charged or negatively-charged electret fine particles by way of pulverizing previously-prepared electret material (e.g. a film). The particles produced by the pulverization have a large particle diameter and therefore require screening; production yield is decreased as a result. Patent Literature 2 discloses another electret fine particle production method that also involves resin pulverization and screening. This method has the same problem as that of Patent Literature 1. Patent Literature 2 also discloses production method in which a molten resin is extruded into the air or into a fluid while a voltage is applied thereto, or in which the resin is sprayed. However, this method has many problems including the limited size of the extrusion outlet, adhesion/aggregation of the sprayed particles, and the like. These problems hinder miniaturization of the particles to the desired extent and thereby decrease the production efficiency.

Accordingly, there have been demands for a technology that enables easy and efficient production of electret fine particles without the conventional pulverization process or screening process.

### CITATION LIST

### Patent Literature

[PTL 1] Japanese Unexamined Patent Publication No. 2005-31189

[PTL 2] Japanese Unexamined Patent Publication No. 2007-206570

### SUMMARY OF THE INVENTION

### Technical Problem

An object of the present invention is to provide a method that enables easy and efficient production of fine electret fine particles without the conventional pulverization or screening process.

### Technical Solution

The inventor of the present invention conducted extensive research to solve the foregoing problems, and found that the above object can be attained by producing fine particles by emulsifying a fluorine-containing compound or fluorine-containing polymerizable compound in the liquid phase under atmospheric or elevated pressure. With this finding, the inventors completed the present invention.

Specifically, the present invention relates to the following electret fine particle production process. Item 1. A method of producing electret fine particles, comprising emulsifying a fluorine-containing compound in a liquid phase under atmospheric or elevated pressure in a liquid that is incompatible with the fluorine-containing compound, to obtain emulsified particles, and irradiating the emulsified particles with an electron ray or a radial ray.

Item 2. The method of producing electret fine particles according to Item 1, wherein the emulsified particles are processed into microcapsules to obtain microcapsule particles, and the microcapsule particles are irradiated with an electron ray or a radial ray.
Item 3. The method of producing electret fine particles according to Item 2, wherein the microcapsule particles are redispersed in a electrophoretic medium and then irradiated with an electron ray or a radial ray.
Item 4. A method of producing electret fine particles, comprising emulsifying a fluorine-containing polymerizable compound in a liquid phase under atmospheric or elevated pressure in a liquid that is incompatible with the fluorine-containing polymerizable compound, to obtain emulsified particles, curing the emulsified particles to obtain cured particles, and irradiating the cured particles with an electron ray or a radial ray.
Item 5. The method of producing electret fine particles according to Item 4, wherein the cured particles are redispersed in an electrophoretic medium and then irradiated with an electron ray or a radial ray.
Item 6. The method of producing electret fine particles according to Item 4 or 5, wherein the emulsified particles are processed into microcapsules to obtain microcapsule particles before being cured.
Item 7. The method of producing electret fine particles according to Item 4 or 5, wherein the cured particles are processed into microcapsules to obtain microcapsule particles before being irradiated with an electron ray or a radial ray.
Item 8. The method of producing electret fine particles according to any one of Items 1 to 7, wherein the emulsified particles contain a hydrophobic pigment.
Item 9. The method of producing electret fine particles according to any one of Items 1, 2, 4, and Items 6 to 8, wherein the liquid that is incompatible with the fluorine-containing compound or the fluorine-containing polymerizable compound is an electrophoretic medium.
Item 10. The method of producing electret fine particles according to any one of Items 1 to 9, wherein the mean particle diameter of the electret fine particles falls within the range of 0.01 to 20 μm.

The following specifically explains the electret fine particle production process according to the present invention.

The electret fine particle production process according to the present invention is roughly classified into a method using a fluorine-containing (unpolymerized) compound as detailed in the First Embodiment and a method using a fluorine-containing polymerizable compound as detailed in the Second Embodiment.

### First Embodiment

The production process according to First Embodiment involves the emulsification of a fluorine-containing compound in the liquid phase under atmospheric or elevated pressure in a liquid that is incompatible with the fluorine-containing compound, to produce emulsified particles, which are then irradiated with an electron ray or a radial ray to produce electret fine particles. A suitable example of a fluorine-containing compound having a liquid phase under elevated pressure is a fluorine-containing compound having a liquid phase at a temperature of about 0° C. to 100° C., and a pressure of 5 to 30 bar. When this compound is used, the above production of emulsified particles is carried out in the condition under which the compound is in the liquid phase). Examples of the fluorine-containing compound include various known fluorine-containing resins, fluorine-containing oils, fluorine-containing adhesives, and the like.

Examples of the fluorine-containing resins include tetrafluoroethylene resin and the like, such as polytetrafluoroethylene (PTFE) represented by FR₁C=R₁R₂, wherein R₁=F or H, R₂=F or H or Cl or other arbitrary elements.

Examples of the fluorine-containing oils include perfluoropolyether oil, chlorotrifluoroethylene oligomer, and the like, such as perfluoropolyether oil (product name: “DEMNUM”, Daikin Industries, Ltd.), chlorotrifluoroethylene oligomer (product name: “DAIFLOIL”, Daikin Industries, Ltd.), and the like.

Examples of the fluorine-containing adhesives include ultraviolet-curable fluorinated epoxy adhesives and the like, such as (product name: “OPTODYNE” Daikin Industries, Ltd.).

The liquid that is incompatible with the fluorine-containing compound is not limited. Examples of these liquids include water, ethylene glycol (EG), propylene glycol (PG), glycerin, and silicone oil. A suitable liquid is selected from these liquids depending on the fluorine-containing compound to be used. Further, a so-called electrophoretic medium may be used as the liquid that is incompatible with the fluorine-containing compound. Examples of the electrophoretic media include ethylene glycol (EG), propylene glycol (PG), glycerin, silicone oil, fluorine-containing oil, and petroleum oil. Examples of silicone oil include dimethyl silicone oil and the like. Examples of fluorine-containing oil include perfluoropolyether oil and the like.

Examples of the emulsifiers for emulsifying the liquid fluorine-containing compound include polyvinyl alcohol and ethylene maleic anhydride. The content of the emulsifier in the liquid that is incompatible with the fluorine-containing compound is preferably about 1 to 10 wt %. Emulsified particles may be prepared by supplying those components in a known mixing device such as a stirrer, mixer, homogenizer, or the like, and evenly mixing them. Mixing is preferably performed under heat.

It is possible to obtain colored emulsified particles by incorporating a hydrophobic pigment in the fluorine-containing compound in advance. In this case, colored electret fine particles, which are useful as material for full-color electronic paper, are obtained.

The hydrophobic inorganic pigment is not limited. For example, black pigments containing carbon as a main component, such as carbon black, lamp black, bone black, or botanical black, can be used. As white pigments, titanium oxide, zinc oxide, calcium carbonate, barium sulfate, and silicon oxide can be used. The white pigments are useful for production of white electrophoretic particles or for the adjustment of the specific gravity of the particles.

The hydrophobic organic pigment is not limited. Examples of hydrophobic organic pigments include azo pigments such as β-naphthol-based pigments, naphthol AS-based pigments, acetoacetic acid-based pigments, aryl amide-based pigments, pyrazolone-based pigments, β-naphthol-based pigments, β-oxynaphthoic acid-based pigments (BON acid-based azo pigments), naphthol AS-based pigments, or acetoacetic acid allylide-based pigments; and polycyclic pigments, such as phthalocyanine-based pigments, anthraquinone-based (threne) pigments, perylene-based or perinone-based pigments, indigo-based or thioindigo-based pigments, quinacridone-based pigments, dioxazine-based pigments, isoindolinone-based pigments, quinophthalone-based pigments, metal complex pigments, methine-based or azo methine-based pigments, diketopyrrolopyrrole-based pigments, or the like. In addition, azine pigments, daylight fluorescent pigments (resin dye solid solution), hollow resin pigments, nitroso pigments, nitro pigments, natural pigments, and the like may also be used.

The hydrophobic organic pigment may be selected from commercial products, such as Symuler Fast Yellow 4GO, Fasdtogen Super Magenta RG, Fasdtogen Blue TGR (DIC Corporation), Fuji Fast Red 7R3300E, Fuji Fast Carmine 527 (Fuji Shikiso K.K.), and the like.

The particle diameter of each hydrophobic pigment is preferably about 0.02 to 20 μm, more preferably about 0.02 to 3 μm.

The mean particle diameter of the obtained emulsified particles is not limited, but preferably is in a range of about 0.01 to 20 μm, more preferably about 0.1 to 5 μm.

The emulsified particles may be directly processed by an electron ray or a radial ray into electret particles; however, it is more preferable to first subject the particles to microcapsulation to obtain microcapsule particles before processing them into electret fine particles. The microcapsulation can be easily performed by mixing the emulsified particles with the wall material of the microcapsules and stirring the mixture.

The microcapsules may have any known structure, provided that they have emulsified particles incorporated therein. For example, the microcapsules may be formed by incorporating emulsified particles in the wall material.

Generally, a resin-based wall film is suitable for the wall material. Examples of the resin include various thermoplastic resins and thermosetting resins, such as epoxy resins, polyamide resins, acrylonitrile resins, polyurethane resins, polyurea resins, urea-formaldehyde-based resins, melamine-formaldehyde-based resins, benzoguanamine resins, butylated melamine resins, butylated urea resins, urea-melamine-based resins, and the like. The resin materials for the resin component may be used alone or in a combination of two or more kinds. When the particles are processed into microcapsules, the microcapsulation may be appropriately performed by polymerizing the resin materials.

The method for microcapsulation may be selected from, for example, interfacial polymerization (polycondensation, addition condensation), in situ polymerization, coacervation method, drying-in liquid method, spray-drying method, and the like.

For example, the microcapsulation may be carried out using in situ polymerization, comprising a first step of stirring the fluorine-containing compound (corresponding to the oil phase in the later-described example); a second step of stirring a mixture (corresponding to the water phase in the later-described example) of the emulsifier and a liquid that is incompatible with the fluorine-containing compound; a third step of stirring the water phase to mix it with the oil phase, thereby preparing emulsified particles; and a fourth step of adding the above resin as a wall material to the emulsion of the emulsified particles and stirring the mixture under heat. With this method, the microcapsules are appropriately produced.

The emulsified particles or microcapsule particles can be processed into electret particles by irradiating the emulsified particles or microcapsule particles, which are either in the form of a suspension or are redispersed in an electrophoretic medium, by an electron ray or a radial ray. The conditions of irradiation using an electron ray or a radial ray are not limited insofar as the emulsified particles or microcapsule particles are properly processed into electret particles. For example, the irradiation may be carried out by emitting an electron ray of about 10 to 50kGy using an electron linear accelerator. Radial ray irradiation may be performed, for example, by emitting a gamma ray of about 1 to 15kGy.

Using the above method, electret fine particles in a range of about 0.01 to 20 μm that have high uniformity can be obtained with high efficiency in an appropriate embodiment. The production process of the present invention enables easy production of electret fine particles having high uniformity that are almost entirely charged to or charged beyond a certain extent (negatively charged) at a high yield, without requiring conventional pulverization or screening.

### Second Embodiment

The production process according to Second Embodiment involves the emulsification of a liquid fluorine-containing polymerizable compound under atmospheric or elevated pressure in a liquid that is incompatible with the fluorine-containing polymerizable compound, to produce emulsified particles, which are then cured before being irradiated with an electron ray or a radial ray to produce electret fine particles. A suitable example of the fluorine-containing polymerizable compound having a liquid form phase) under elevated pressure is a fluorine-containing polymerizable compound having a liquid phase at a temperature of about 0° C. to 100° C., and a pressure of 5 to 30 bar. When this compound is used, the emulsified particles are prepared under conditions in which the compound is in the liquid phase). Examples of the fluorine-containing polymerizable compound include various known fluorine-containing elastomers, fluorine-containing varnishes, polymerizable fluorocarbon resins, and the like.

Examples of the fluorine-containing elastomers include straight-chain fluoropolyether compounds, such as “SIFEL3590-N”, “SIFEL2610”, “SIFEL8470” (all are products of Shin-Etsu Chemical Co., Ltd.), and the like.

Examples of the fluorine-containing varnishes include tetrafluoride ethylene/vinyl monomer copolymer (product name: “Zeffle”, Daikin Industries, Ltd.) and the like.

Examples of the polymerizable fluorocarbon resins include polymerizable amorphous fluorocarbon resin (product name: “CYTOP”, Asahi Glass Co., Ltd.) and the like.

The liquid that is incompatible with the fluorine-containing polymerizable compound is not limited, and aforementioned examples of liquids that are incompatible with the fluorine-containing compounds may be used. Further, the same emulsifiers and hydrophobic pigments indicated above may be used. The mean particle diameter of the particles resulting from the emulsification is not limited, but preferably is about 0.01 to 20 μm, and more preferably about 0.1 to 5 μm.

In Second Embodiment, the emulsified particles are cured with heat, ultraviolet irradiation, or the like. When curing with heat, for example, the emulsified particles are heated at about 80° C. for about an hour. When curing with ultraviolet irradiation, the emulsified particles undergo 1 to 2J/cm² ultraviolet irradiation having a wavelength of 365 nm.

As required, the emulsified particles may be processed into microcapsules in the manner mentioned above, before or after being cured.

The cured particles or microcapsule particles can be processed into electret particles by irradiating the particles, which are either in the form of suspension or being redispersed in an electrophoretic medium, using an electron ray or a radial ray. The conditions of irradiation with an electron ray or a radial ray are not limited insofar as the emulsified particles or microcapsule particles are properly processed into electret particles. For example, irradiation is carried out by emitting an electron ray of about 10 to 50kGy using an electron linear accelerator. Radial ray irradiation may be performed, for example, by emitting a gamma ray of about 1 to 15kGy.

With the above method, electret fine particles in a range of about 0.01 to 20 μm that have high uniformity can be obtained with high efficiency in an appropriate embodiment. The production process of the present invention enables easy production of electret fine particles having high uniformity that are almost entirely charged to or beyond a certain extent (a negative charge) at a high yield, without requiring conventional pulverization or screening.

### EFFECT OF THE INVENTION

The production process according to the present invention enables easy production of electret fine particles having a highly uniform particle diameter, without requiring conventional pulverization or screening. The electret fine particles are useful for electret fine particles for electrophotography toner, electronic papers, or the like. The electret fine particles are charged to a high voltage and thereby allow for an increase in rewriting speed. Further, the highly uniform fine particles allow high definition images to be created. The fine particles are also useful as materials for electret fibers, nonwoven fabric, filtering media (filters), vacuum cleaner bags, electret capacitor microphones, and the like.

### BRIEF DESCRIPTION OF DRAWINGS

FIG. 1 is a drawing showing an SEM image and a particle size distribution measurement of microcapsule fine particles obtained in Example 1 (Composition A) and Example 2 (Composition B).

FIG. 2 is a drawing showing an SEM image and a particle size distribution measurement of microcapsule fine particles obtained in Example 3 (Composition C), Example 4 (Composition D) and Example 5 (Composition E).

### BEST MODE FOR CARRYING OUT THE INVENTION

The following more specifically describes the present invention with reference to preparation examples and a test example. However, the present invention is not limited to these examples.

Tables 1 and 2 show the names and the properties of the fluorine-containing compounds (fluorine-containing oil) and fluorine-containing polymerizable compounds (fluorine-containing elastomers) used in the preparation examples.

TABLE 1

| Manufacturer | Daikin Industries, Ltd.(Fluorocarbon Oils) | |
|---|---|---|
| Name | DEMNUM S-65 | DAIFLOIL #1 |
| Structure | Straight-chain | Ethylene Chloride Trifluoride |
| | Perfluoropolyether | Oligomer |
| | (PFPE) Oil | |
| Viscosity | 150 cSt (20° C.) | 10 to 30 mPa · s (25° C.) |
| Specific | 1.873 (20° C.) | 1.85 to 1.89 (25° C.) |
| Gravity | | |
| Surface | 18.0 mN/m | 26 to 28 mN/m |
| Tension | | |

TABLE 2

| Manufacturer | Shin-Etsu Chemical Co., Ltd. (Fluorocarbon Elastomer) | | |
|---|---|---|---|
| Name | SIFEL3590-N | SIFEL2610 | SIFEL8470 |
| Structure | Fluorocarbon Polyether Skeleton and Silicone Crosslinking | | |
| | Reaction Group at the Terminal | | |
| | 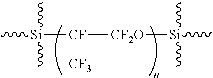 | | |
| Viscosity | 50 Pa·s (23° C.) | 6 Pa·s (23° C.) | 3.2 Pa·s (23° C.) |
| Density | 1.88 g/cm³ | 1.77 g/cm³ | 1.84 g/cm³ |
| | (23° C.) | (23° C.) | (25° C.) |
| Hardness | Penetration: 55 | Penetration: 35 | Penetration: 70 |
| Appearance | Milky White | Milky White | Transparent Pale |
| | Liquid | Liquid | Yellow |

TABLE 3

| | |
|---|---|
| Manufacturer | Daikin Industries, Ltd. |
| | (Fluorocarbon Varnishe) |
| Name | Zeffle GK-570 |
| Structure | Tetrafluoride ethylene/vinyl monomer |
| | copolymer |
| Viscosity | 700 to 2100 mPa · s (20° C.) |

### Preparation Examples 1 and 2

### Preparation of Microcapsule Fine Particles

Three kinds of mixture materials formed of Compositions A, B, and A′ were prepared. Composition A′ has the same composition as that of Composition A except for incorporation of a pigment (Fastgen super magenta RG))

TABLE 4

| Composition A | | Composition B | |
|---|---|---|---|
| (1) Water Phase | | (1) Water Phase | |
| (Emulsifier) | | (Emulsifier) | |
| Ion-exchange Water | 48.3 g | Ion-exchange Water | 48.3 g |
| Caustic soda 20P liquid | 1.0 g | Caustic soda 20P liquid | 1.0 g |
| ZEMAC E400 | 1.8 g | ZEMAC E400 | 1.8 g |
| Total | 51.0 g | Total | 51.0 g |
| (2) Oil Phase | | (2) Oil Phase | |
| DEMNUM S-65 | 35.0 g | Daifloil #1 | 35.0 g |
| (3) Wall Material | | (3) Wall Material | |
| Ion-exchange water | 10.0 g | Ion-exchange water | 10.0 g |
| Melamine | 3.0 g | Melamine | 3.0 g |
| Formalin | 7.5 g | Formalin | 7.5 g |
| Total | 20.5 g | Total | 20.5 g |

Composition A′

| | |
|---|---|
| (1) Water Phase (Emulsifier) | |
| Ion-exchange water | 48.3 g |
| Caustic soda 20P liquid | 1.0 g |
| ZEMAC E400 | 1.8 g |
| Total | 51.0 g |
| (2) Oil Phase | |
| DEMNUM S-65 | 35.0 g |
| Fastgen super magenta RG (Pigment) | 0.4 g |
| Total | 35.4 g |
| (3) Wall Material | |
| Ion-exchange water | 10.0 g |
| Melamine | 3.0 g |
| Formalin | 7.5 g |
| Total | 20.5 g |

(In the table, ZEMAC E400 is an emulsifier (Ethylene maleic anhydride copolymer)

The preparation was carried out as follows.

The water phase component was stirred at room temperature, followed by further stirring while heating at 75° C. for an hour. The resulting liquid was cooled at room temperature to prepare a water phase.

A mixture obtained by adding ion exchange water to melamine was stirred while heating (65° C., 1000 rpm, 5 minutes). After adding formalin, the mixture was stirred while heating (65° C., 1000 rpm, 15 minutes) to prepare a wall material.

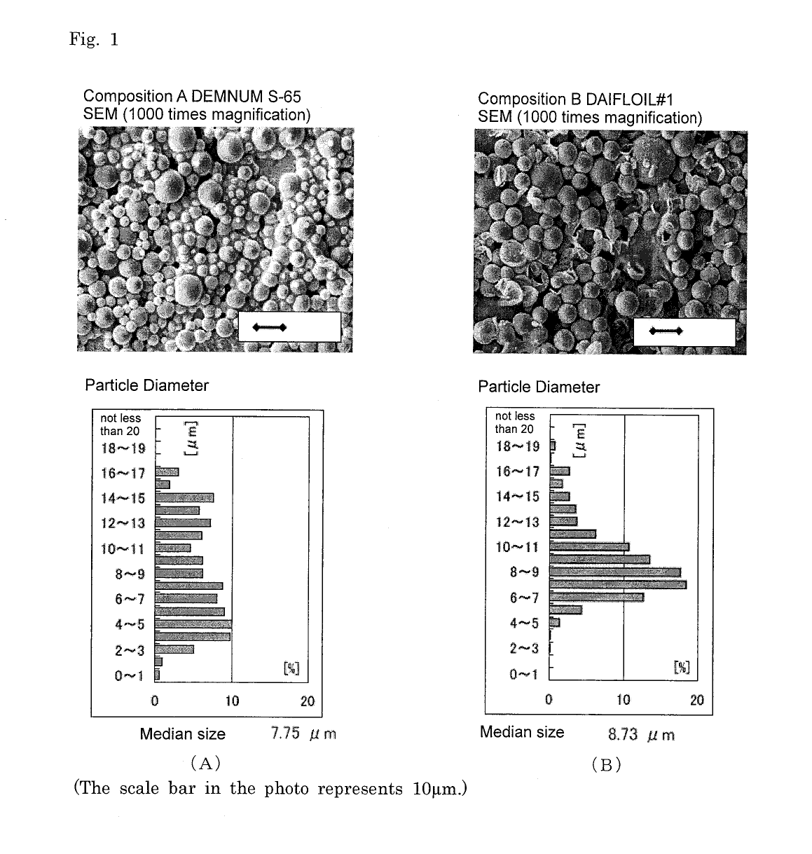

The oil phase was added to the water phase while stirring (20° C., 1500 rpm, 5 minutes). The mixture of the water phase and the oil phase was heated to 75° C., the wall material was added thereto, and the mixture was heated while stirring (65° C., 1000 rpm, 2 hours). A suspension in which microcapsule fine particles were dispersed was obtained. FIG. 1 shows an SEM image and a particle size distribution measurement of the microcapsule fine particles.

### Preparation Examples 3 to 5

### Preparation of Polymerizable Fine Particles

Five kinds of mixture materials formed of Compositions C, D, E, F, and C′ were prepared. Composition C′ has the same composition as that of Composition C except for incorporation of a pigment (Symuler fast yellow).

TABLE 5

| Composition C | | Composition D | | Composition E | |
|---|---|---|---|---|---|
| (1) Emulsifier | | (1) Emulsifier | | (1) Emulsifier | |
| Ion-exchange water | 90.0 g | Ion-exchange water | 90.0 g | Ion-exchange water | 90.0 g |
| PVA224 | 10.0 g | PVA224 | 10.0 g | PVA224 | 10.0 g |
| Total | 100.0 g | Total | 100.0 g | Total | 100.0 g |
| (2) Fluorocarbon Elastomer | | (2) Fluorocarbon Elastomer | | (2) Fluorocarbon Elastomer | |
| SIFEL3590-N | 10.0 g | SIFEL2610 | 10.0 g | SIFEL8470 | 10.0 g |

| | |
|---|---|
| Composition F | Composition C′ |

| | | | |
|---|---|---|---|
| (1) Emulsifier | | (1) Emulsifier | |
| Ion-exchange water | 90.0 g | Ion-exchange water | 90.0 g |
| PVA224 | 10.0 g | PVA224 | 10.0 g |
| Total | 100.0 g | Total | 100.0 g |
| (2) Fluorocarbon varnishe + | | (2) Fluorocarbon Elastomer + | |
| Pigment | | Pigment | |
| Zeffle GK-570 | 10.0 g | SIFEL3590-N | 10.0 g |
| Desmodur L75C | 2.4 g | Symuler fast yellow | 1.0 g |
| (Curing agent) | | (Pigment) | |
| Symuler fast yellow | 1.0 g | Total | 11.0 g |
| (Pigment) | | | |
| Total | 13.4 g | | |

(In the table, PVA224 is a thickener (polyvinyl alcohol))

The preparation was carried out as follows.

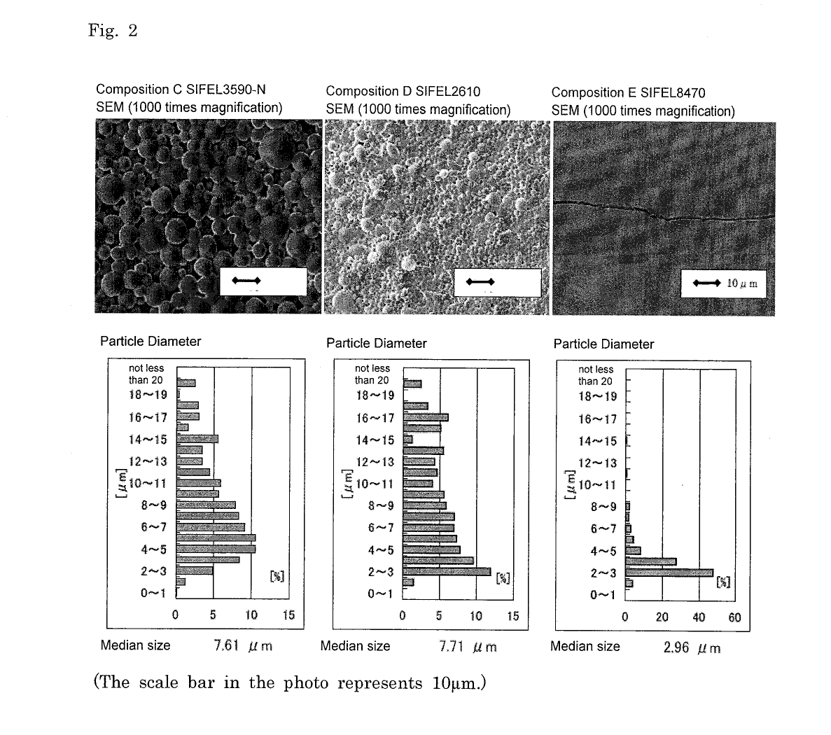

A fluorine-containing elastomer (composition example: C, D, E, and C′) or a fluorine-containing varnish (composition example: F) was added to an emulsifier and stirred with a homo mixer (6000 rpm, 6 minutes). Thereafter, the emulsion was heated while stirring using a dissolver (300 rpm, 80° C., 8 hours). A suspension in which particles were dispersed was obtained. FIG. 2 shows an SEM image and a particle size distribution measurement of the particles.

### Test Example 1

### Electrophoresis Test

The fine particles obtained in Preparation Examples 1 to 5 were separately dispersed in a white insulating liquid (silicon oil, KF96L-0.65, Shin-Etsu Chemical Co., Ltd.).

2 cc of each dispersion was wrapped with two 7 cm×7 cm PET films (Mylar 850, 15 to 30 μm in thickness: produced by Teijin) and the four corners of the layered films were sealed by heating. The entire thickness was 0.5 to 1 μm. Then, the dispersion liquid was irradiated with an electron ray using an electron linear accelerator (10 minutes irradiation at 400 keV, 150μA), thereby processing the dispersion into electret fine particles. Five kinds of sample electret fine particle dispersions were obtained.

For comparison, another five samples were prepared with no electron ray irradiation.

Each end of the samples and the comparative samples was clipped to a terminal of a high voltage power supply. 2000V was applied across the clips on both ends, and electrophoresis was observed.

The samples processed into electret fine particles underwent regular electrophoretic migration at high speed, and all particles were moved to the positive electrode. In contrast, the samples of non-electret fine particles underwent irregular electrophoretic migration, and the particles were separated to the positive electrode and the negative electrode.

1. A method of producing electret fine particles, comprising emulsifying a fluorine-containing compound in a liquid phase under atmospheric or elevated pressure in a liquid that is incompatible with the fluorine-containing compound, to obtain emulsified particles, and irradiating the emulsified particles with an electron ray or a radial ray.

2. The method of producing electret fine particles according to claim 1, wherein the emulsified particles are processed into microcapsules to obtain microcapsule particles, and the microcapsule particles are irradiated with an electron ray or a radial ray.

3. The method of producing electret fine particles according to claim 2, wherein the microcapsule particles are redispersed in a electrophoretic medium and then irradiated with an electron ray or a radial ray.

4. A method of producing electret fine particles, comprising emulsifying a fluorine-containing polymerizable compound in a liquid phase under atmospheric or elevated pressure in a liquid that is incompatible with the fluorine-containing polymerizable compound, to obtain emulsified particles, curing the emulsified particles to obtain cured particles, and irradiating the cured particles with an electron ray or a radial ray.

5. The method of producing electret fine particles according to claim 4, wherein the cured particles are redispersed in an electrophoretic medium and then irradiated with an electron ray or a radial ray.

6. The method of producing electret fine particles according to claim 4, wherein the emulsified particles are processed into microcapsules to obtain microcapsule particles before being cured.

7. The method of producing electret fine particles according to claim 4, wherein the cured particles are processed into microcapsules to obtain microcapsule particles before being irradiated with an electron ray or a radial ray.

8. The method of producing electret fine particles according to claim 1, wherein the emulsified particles contain a hydrophobic pigment.

9. The method of producing electret fine particles according to claim 1, wherein the liquid that is incompatible with the fluorine-containing compound or the fluorine-containing polymerizable compound is an electrophoretic medium.

10. The method of producing electret fine particles according to claim 1, wherein the mean particle diameter of the electret fine particles falls within the range of 0.01 to 20 μm.
